(19) United States
(12) Patent Application Publication
(10) Pub. No.: US 2002/0013748 A1
(43) Pub. Date: Jan. 31, 2002

(54) Metadata-driven statistics processing

(76) Inventors: Kelvin Edmison, Ottawa (CA); Steve Bergwerff, Ottawa (CA); Benoit Godin, Ottawa (CA)

Correspondence Address: Marks & Clerk, P.O. Box 957, Station B, Ottawa, ON, K1P 5S7, CA

(21) Appl. No.: 09/866,706

(22) Filed: May 30, 2001

(30) Foreign Application Priority Data
May 30, 2000 (CA) 2,310,150

(51) Int. Cl. G06F 17/60

(52) U.S. Cl. 705/35

(57) ABSTRACT

A method for generating statistical information for performance management reporting is provided. Raw statistical information provided by managed data network equipment is described in a body of vendor data network equipment specific metadata—the collection of which is referred to as vendor statistics metadata. The statistical information needed for performance reporting is described in a body of performance reporting metadata. The method has a sequence of steps. In an initial syntactic translation step, the vendor statistics metadata is used to transform raw statistical information provided by managed data network equipment into a common format removing vendor dependencies while maintaining vendor semantics. In a second semantic extraction step, the statistical information for performance reporting is extracted in accordance to specifications described in a body of statistics semantic mapping metadata from a body of common format statistic information in accordance with prespecified preferences. This method of generating statistical information for performance management reporting enables faster integration of new vendor equipment in managed data network segments, faster integration of new services, faster integration of upgrades, etc.

### FIELD OF THE INVENTION

The invention relates to management of data transport services, and in particular to methods of generating statistical information for data network performance management report.

### BACKGROUND OF THE INVENTION

The deregulation of telecommunications services has lead to a competitive environment in which data transport service providers deploy data services to subscribers and co-operate in supporting subscribed-to services.

Data transport networks are made up of data transport links interconnecting data transport equipment. A variety of data transport technologies exist for the physical conveyance of data over data transport links, a variety of data transport protocols exist for data transfers between data network nodes and a variety of data transport equipment produced by different vendors must coexist in order to support subscribed-to services end-to-end.

The development of the physical data transport technologies, the data transport protocols and the data transport equipment has progressed in support of specific data transport features. Feature development is driven by customer demand and the vendors' need to differentiate themselves, balanced against a requirement for interoperability between different vendor equipment.

Interoperability between multi-vendor equipment is necessary between core data network equipment and distribution-side equipment. Different segments of data transport networks operate according to different data transport requirements using different data transport technologies typically on different vendor equipment.

Data service providers offering customized data transport services have recognized that loyalty to a single vendor's equipment may reduce operational costs but may not accommodate all customer requirements. Therefore multi-vendor equipment interoperability is necessary even within the realm of a single service provider in order to take advantage of opportunities.

Besides the need for interoperability in provisioning the data transport services, there is a need for interoperability for data network management purposes. Although data transport services are provided in accordance with open standards for interoperability, the approach taken by each data transport equipment vendor in implementation may be different. Performance measurement and reporting has a different meaning for each vendor. Each vendor equipment typically provides vendor specific performance reporting and requires adjusting vendor specific controls.

Therefore a lot of resources are necessary to achieve interoperability between data transport equipment within and between data transport networks in order to support subscribed-to data services.

In particular, for data network management, a large amount of statistical information such as is generated by managed data network elements is processed to: extract a current state of the managed data network elements, log the statistical information, display the current state of the managed data network elements, isolate current problems, monitor trends that could lead to potential problems, determine solutions to problems, issue commands to correct problems, deploy newly activated subscribed-to services, etc. Effective performance management systems need to provide a single view of the state of the managed data network elements across physical data transport networks, data transport protocols, currently deployed data services and currently established data sessions. This field is known as performance management reporting.

As the managed data network elements are manufactured by different vendors, it is of crucial importance that the generated statistical information is extracted effectively.

Prior art methods in the field of extracting statistical information are limited to explicit coding of parsing software to transform the statistical information from a vendor specific data format to a performance management system data format for display. Several drawbacks are encountered in using this approach.

Typically new services are provisioned over already installed resources; in order to support the new services new parsing software is necessary to be coded in support of the new services. Upgrades of managed data networking elements also necessitates re-coding of the parsing software. Upgrades in the performance management system(s) yet again necessitates re-coding of the parsing software. Further, re-coding the parsing software is necessary in order to support new data network equipment. With different vendors rolling out upgrades and improvements several times a year, re-coding the parsing software adds to the overhead in providing data services to end customers.

Therefore, there is a need for methods of reducing the overhead involved in providing effective performance reporting.

### SUMMARY OF THE INVENTION

In accordance with an aspect of the invention, a method of generating statistic information for performance management reporting is provided. The method includes a semantic extraction step. Performance reporting statistics are extracted from common format statistics according to statistic semantic mappings having semantic translation priorities specified in a body of statistics semantic mapping metadata.

If common format statistics are not found in a body of common format statistics as specified by a currently selected statistic semantic mapping having a greatest semantic mapping priority, another statistic semantic mapping having a next greatest semantic mapping priority is chosen until either a semantic mapping priority is satisfied or no other statistic semantic mapping are available.

In generating performance reporting statistics, the method further includes a step of performing operations on common format statistics.

In accordance with another aspect of the invention, the method further includes selecting performance reporting statistics from a body of performance reporting metadata, each performance reporting statistic having a performance reporting statistic identifier used in selecting statistic semantic mapping for the generation of performance reporting statistic.

In accordance with another aspect of the invention, the method includes a syntactic translation step in which raw statistic information provided by a managed network element is converted into a body of common format statistics as specified in a body of vendor statistics metadata for each raw statistic. Each raw statistic is associated with a vendor statistic identifier, the vendor statistic identifier being used to query the vendor statistic metadata in performing the syntactic translation.

In performing the syntactic translation, raw statistics may be subject to unit conversions.

The advantages of the invention are derived from: a reduction in the overhead involved in upgrading vendor data network equipment in a managed data network segment, a reduction in the overhead involved in adding other vendor equipment to the managed data network segment and a reduction in the overhead associated with changes in performance reporting characteristics in managing the performance of the managed data network elements.

### BRIEF DESCRIPTION OF THE DIAGRAMS

The features and advantages of the invention will become more apparent from the following detailed description of the preferred embodiments with reference to the attached diagrams wherein:

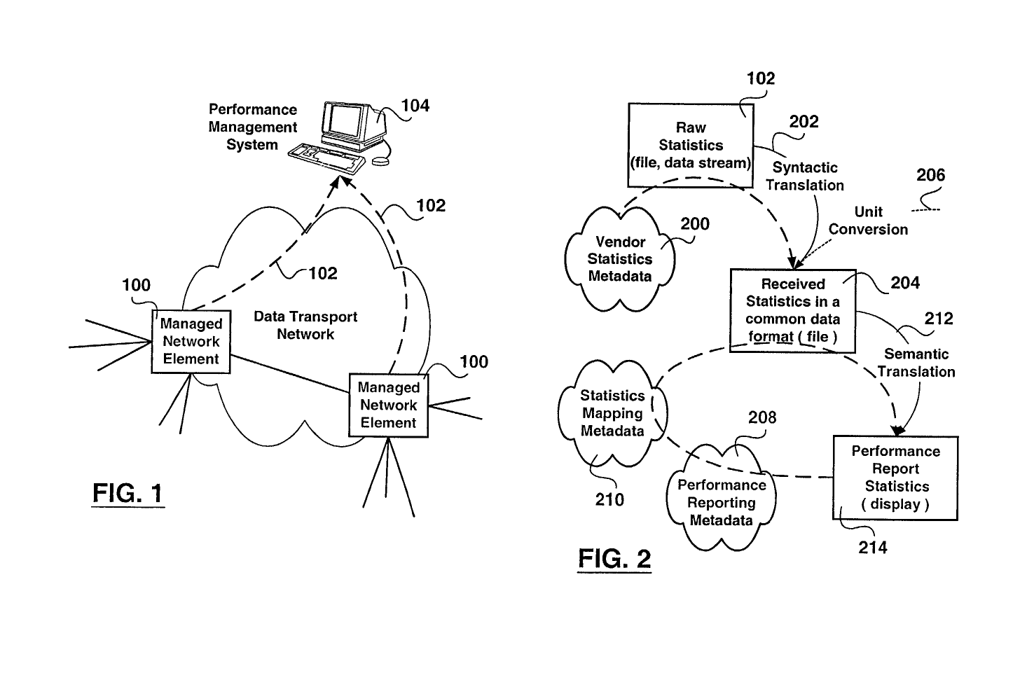

FIG. 1 is a schematic diagram showing interconnected data network elements in a data transport network in accordance with an exemplary embodiment of the invention;

FIG. 2 is a schematic diagram showing an overview of the processing of statistical information for performance management reporting in accordance with a preferred embodiment of the invention;

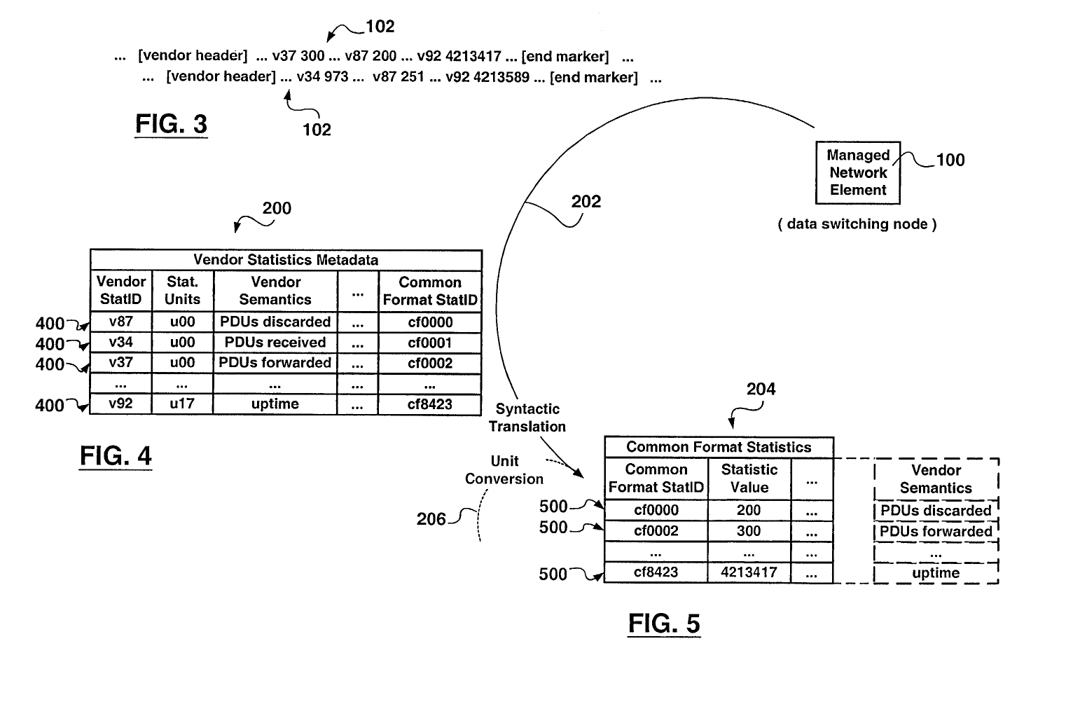

FIG. 3 is a schematic diagram showing raw statistical information provided by a managed data network element;

FIG. 4 is a schematic diagram showing a tabular representation of vendor statistics metadata in accordance with an exemplary embodiment of the invention;

FIG. 5 is a schematic diagram showing a tabular representation of statistical information stored in a common format in accordance with an exemplary embodiment of the invention;

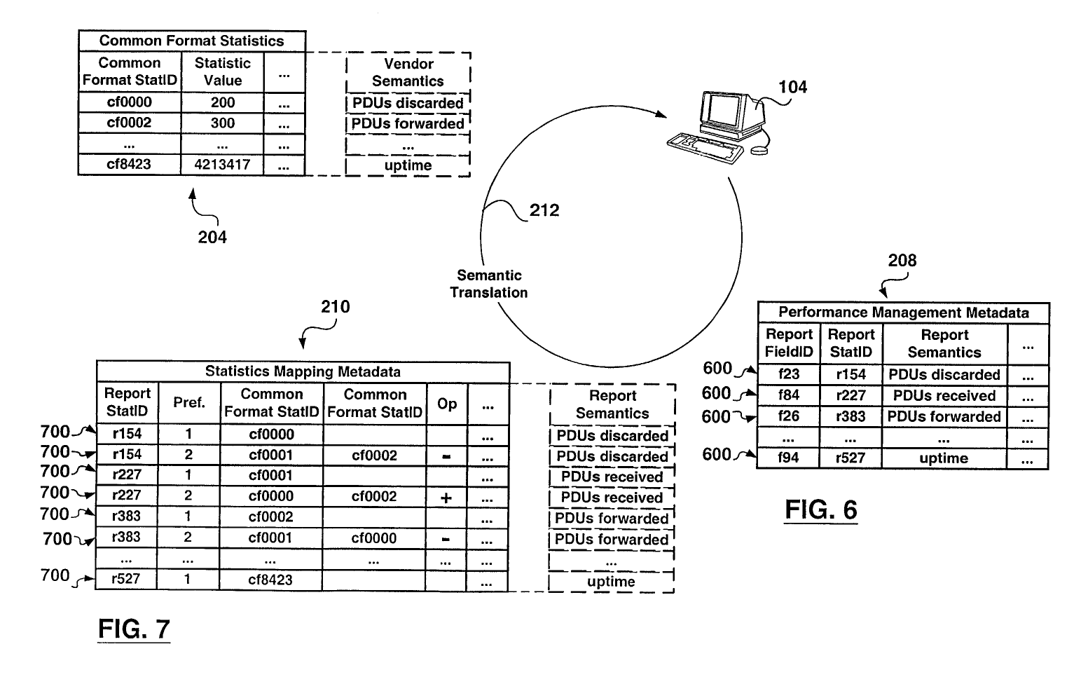

FIG. 6 is a schematic diagram showing a tabular representation of performance management metadata in accordance with an exemplary embodiment of the invention; and

FIG. 7 is a schematic diagram showing a tabular representation of statistics semantic mapping metadata in accordance with an exemplary embodiment of the invention.

It will be noted that in the attached diagrams like features bear similar labels.

### DETAILED DESCRIPTION OF THE EMBODIMENTS

FIG. 1 is a schematic diagram showing interconnected data network elements in a data transport network in accordance with an exemplary embodiment of the invention.

Data network elements 100 are managed and provide performance statistic information 102 to a performance management system 104. Data network elements include but are not limited to: data switching nodes, access concentrators, routers, bridges, etc.

FIG. 2 is a schematic diagram showing an overview of the processing of statistical information for performance management reporting in accordance with a preferred embodiment of the invention.

The statistic information 102 provided by a management network element 100 describes a current state thereof in a format specified by the vendor of the network element 100 and will be referred to herein as raw statistical information 102.

The content of the raw statistical information 102 provided may vary, as specified by the vendor, in accordance with modes of operation of the network element 100. Further details about the raw statistical information 102 will be presented hereinbelow with reference to FIG. 3. The performance management system 104 may monitor a multitude of managed network elements 100.

In accordance with invention, each raw statistic provided in the raw statistical information 102 is described in a body of vendor statistics metadata 200. Further details regarding the vendor statistics metadata 200 will be presented hereinbelow with reference to FIG. 4.

For the purposes of performance reporting, the vendor statistics metadata 200 is consulted in performing a preliminary syntactic translation 202 of the raw statistic information 102.

The raw statistic information 102 is represented in a common data format 204 subsequent to the syntactic translation step 202. The body of common format statistics 204 no longer retains the original vendor syntax (data format) but still retains vendor semantics (meaning of the information represented by the statistic data). Further details with respect to the common format statistics 204 will be presented hereinbelow with reference to FIG. 5. A unit conversion step 206 may have to be performed in generating the common format statistics 204.

Typically, what is reported by the vendor equipment might not be exactly what is necessary in performance management reporting. It is likely that what needs to be presented in performance management reporting is a combination of the raw statistic information provided by the vendor.

In accordance with the invention, the performance report statistic information 214 displayed in a report (reported statistic information) is described in a body of performance reporting metadata 208. Further details regarding the performance reporting metadata 208 will be presented hereinbelow with reference to FIG. 6.

In accordance with the invention, a body of statistics semantic mapping metadata 210 is further provided to enable a semantic extraction 212 of performance report statistics 214 from the common format statistics 204. Further details regarding the statistic semantic mapping metadata 210 will be provided hereinbelow with reference to FIG. 7.

FIG. 3 is a schematic diagram showing raw statistical information provided by a managed data network element.

The raw statistical information 102 may be provided as: a continuous data stream having a repetition rate, data transfers provided on a regular basis, query responses, etc. Shown in the diagram are portions of raw statistic information files 102 produced by a data switching node 100.

For the purposes of this example, the data switching node 100 is not a source of data in the data transport network in which it participates. As such the data switching node 100 can only: receive Protocol Data Units (PDUs), forward PDUs and discard PDUs. PDUs include but are not limited to: frames, cells, packets, etc.

As mentioned above, the content of the statistical information 102 provided may vary as specified by the vendor in accordance with modes of operation of the managed network element 100.

An example of content variance is the provision of raw statistic v37 in a raw statistic information file 102 and its replacement with raw statistic v34 in another (subsequent) raw statistic information file 102.

FIG. 4 is a schematic diagram showing a tabular representation of vendor statistics metadata in accordance with an exemplary embodiment of the invention.

The vendor statistics metadata 200 is represented in tabular format. The invention is not limited thereto, persons of ordinary skill in the art would recognize that other methods of representing metadata may be used without departing from the spirit of the invention. A vendor statistics metadata table 200 is typically provided for each vendor/equipment type combination. The correlation between a particular vendor statistic metadata table 200 and raw statistic information file 102 is made using information provided by the vendor in a file header of each one of the raw statistic information files 102.

The vendor statistics metadata table 200 includes row entries 400. Each row entry 400 includes: a vendor statistic identifier specification, a statistic unit, a vendor description of the statistic (semantic information), and a common format statistic identifier. Other information may be stored as necessary to facilitate the syntactic translation of the raw statistic information 102 into the common format statistics 204 without departing from the spirit of the invention.

For example, details about raw statistics v34, v37, v87 and v92 are shown: raw statistic v34 represents a number of PDUs received by the data switching node 100, raw statistic v37 represents a, number of PDUs forwarded by the data switching node 100, raw statistic v87 represents a number of PDUs discarded by the data switching node 100 and vendor statistic v92 represents a number of time ticks since the last restart of the data switching node 100.

Raw statistics v34, v37, v87 and v92 have unit specifications u00, u00, u00 and u17 respectively as provided by the vendor. For example, u17 represents a unit of time specifying the duration of one time tick. Different units may be specified for different raw statistics even within a single raw statistic information file 102. As an example, the passage of time may be specified in microseconds, seconds, etc. and referenced to the GMT, the UMT standard, etc.

The vendor statistics metadata 200 is not limited to what is shown in FIG. 4, additional information may be held as it facilitates the syntactic translation 202 of the raw statistic information 102 into the common format statistics 204. Of importance are vendor statistic qualifiers (not shown) which provide extended information about the vendor statistics such as the type of counters: rolling, interval, differential, etc. The meaning of rolling, interval and differential counters is know to a person of ordinary skill in the art who understands that such information may be added to or taken away from the vendor statistics metadata 200 without departing from the spirit of the invention.

Also held in each row entry of the vendor statistics metadata table 200 is a common format statistic identifier facilitating the syntactic translation of the raw statistic information 102 into the common format statistics 204. As an example raw statistics v34, v37, v87 and v92 have common format statistic identifiers cf0001, cf0002, cf0000 and cf8423 respectively.

The use of vendor statistics metadata 200 reduces the overhead in re-coding parsing software for interpreting raw statistical information 102 with: changes in vendor provided statistic information, the addition of data equipment from other vendors to a managed data network segment, etc.

FIG. 5 is a schematic diagram showing a tabular representation of statistical information stored in a common format in accordance with an exemplary embodiment of the invention.

The syntactic translation step 202, as presented above, generates common format statistics 204 a tabular representation of which is shown to include row entries 500. The invention is not limited to the tabular representation of the common format statistics 204 and a person of ordinary skill in the art would appreciate that other representation of common format statistics 204 may be used without departing from the spirit of the invention.

Each common format statistic entry 500 includes at a minimum a statistic value and the corresponding common format statistic identifier. The particular common format statistics 204 shown correspond to the first raw statistic information file 102 presented in FIG. 3: common format statistic common format statistic identifier cf0000 has a statistic value of 200, common format statistic common format statistic identifier cf0002 has a statistic value of 300 and common format statistic common format statistic identifier cf8423 has a statistic value of 4213417. The common format statistics 204 retain the vendor semantics but the associated values may have been subject to unit conversion (206) in the syntactic translation step 202. The storage of units in entries 500 is optional since the unit conversion step 206 provides a normalization of vendor provided units.

FIG. 6 is a schematic diagram showing a tabular representation of performance reporting metadata in accordance with an exemplary embodiment of the invention.

Typically performance management reporting statistic information is presented to an analyst in the form of a performance report.

In accordance with the invention the presentation of the performance management reporting statistic information in the performance report is described in a body of performance reporting metadata 208. In the diagram the performance reporting metadata 208 is represented in tabular format. The invention is not limited to the tabular representation thereof and persons of ordinary skill in the art would appreciate that other representation of performance reporting metadata exist and may be used without departing from the spirit of the invention.

The performance reporting metadata table 208 includes row entries, each row entry 600 storing specifications of a report field identifier corresponding to a performance report statistic identifier. A performance report field descriptor (semantic information) may also be provided as well as other information aiding in the presentation of performance management report statistic information in the performance report.

In accordance with the example shown, the performance report field identifiers f23, f26, f84, and f94 correspond to report fields which are to be populated with values of performance report statistics having performance report statistic identifiers r154, r383, r227 and r527 respectively.

The use of performance reporting metadata 208 reduces the implementation overhead in modifying performance reports for performance management reporting purposes and eliminates the need for explicit re-coding of performance management reporting interfaces with each upgrade, changes in service offerings, and/or the addition of new equipment to a managed data network segment.

FIG. 7 is a schematic diagram showing a tabular representation of statistics semantic mapping metadata in s accordance with an exemplary embodiment of the invention.

In accordance with the invention, a body of statistics semantic mapping metadata 210 is provided for extracting (212) performance report statistics 214 for performance management reporting purposes from a body of common format statistics 204. The extraction process step is also known as a semantic translation step (212) as performance report statistics 214 having performance report semantics are generated from common format statistics 204 having vendor provided semantics.

The representation of the statistics semantic mapping metadata 210 is not limited to the tabular format shown and persons of ordinary skill in the art would appreciate that other representations may be used without departing from the spirit of the invention.

Row entries 700 in the statistics semantic mapping metadata table 210 specify how the common format statistics 204 are to be used to generate performance report statistics 214. As examples, for the generation of performance report statistics corresponding to performance report statistic identifiers r154, r227, r383 and r527, the statistics values corresponding to common format statistic identifiers cf0000, cf0001, cf0002 and cf8423 may be used directly.

As mentioned above, the content of the raw statistical information files 102 may differ with changes in modes of operation of the managed network equipment 100 and typically what is reported therefrom may not exactly correspond with what is required in performance management reporting but combinations of the provided raw statistical information 102 may fulfill that requirement.

In accordance with the invention, each statistics mapping specified in the statistics semantic mapping metadata 210 is given a semantic mapping priority. The statistics mappings referred to above are shown in the diagram to have a semantic mapping priority of “1”. A semantic mapping preference of “1” is considered to be the greatest semantic mapping preference, a statistic semantic mapping having a semantic mapping preference of “2” would be considered to have a next greatest semantic mapping preference, and so on.

Should a common format statistic identifier specified in the statistic semantic mapping metadata table 210 not be found in the common format statistics table 204, the statistics extraction process consults the statistics semantic mapping metadata table 210 for another row entry corresponding to the same report statistic identifier having a next greatest semantic mapping priority.

In the example shown, each of the performance report statistic identifiers r154, r227 and r383 also have entries 700 bearing semantic mapping priorities of “2”. With response time being an issue of importance in the example, semantic mapping priorities of “2” are given to statistics semantic mapping entries 700 which require calculations to generate performance report statistics. For this purpose, row entries 700 in the statistics semantic mapping metadata table 210 include specifiers for operations to be performed as well as the common format statistic identifiers corresponding to the common format statistics on which the operations are to be performed on.

Persons of ordinary skill in the art would recognize that more than one operation may be specified in the statistic semantic mapping and/or unit conversions may be performed in generating the performance report statistic without departing from the spirit of the invention.

As an example, the performance report statistic corresponding to the performance report statistic identifier r227 may also be generated by adding the statistic value corresponding to the common format statistic identifier cf0000 to the statistic value corresponding to the common format statistic identifier cf0002 as specified in the common format statistics 204.

In summary of the above example and in accordance with the invention, the statistics semantic mapping metadata 210 is used as follows: in reporting the number of PDUs received at the data switching node 100 preferably use the number of PDUs received if provided in the raw statistics information (subject to a unit conversion) Failing that, and therefore less preferably, use the result of adding the number of PDUs discarded to the number of PDUs forwarded, if provided, in the raw statistics information (subject to any necessary unit conversions). Continue trying to determine the value of the performance report statistic by inspecting the statistic semantic mapping metadata 210 for less preferable ways obtaining the performance report statistic. Return a failure in determining the value of the performance report statistic only on not finding suitable combinations of common format statistics to satisfy at least one statistic semantic mapping in the statistics semantic mapping metadata 210 corresponding to the performance report statistic needed to be reported.

The use of statistics semantic mapping metadata reduces the overhead in hard coding routines for extracting performance report statistics from raw statistic information and reduces the overhead in recoding thereof with upgrades, changes in service offerings and the addition of new equipment to managed data network segments.

The use of the methods described herein also aid in supporting other features of performance management reporting systems 104 such as error reporting, error propagation, raising of alarms, etc.

The invention is not limited by the information held in the statistic semantic mapping metadata 210 shown, persons of ordinary skill in the art would appreciate that further information may be added thereto without departing from the spirit of the invention.

The embodiments presented are exemplary only and persons skilled in the art would appreciate that variations to the above described embodiments may be made without departing from the spirit of the invention. The scope of the invention is solely defined by the appended claims.

We claim:

1. A method of generating statistic information for performance management reporting, the method comprising steps of:
a. selecting a statistic semantic mapping for a performance report statistic based on a performance report statistic identifier from a body of statistic semantic mapping metadata, the statistic semantic mapping having a greatest semantic mapping priority associated therewith;
b. extracting a statistic value from a body of common format statistics as specified in the statistic semantic mapping selected;
c. selecting another statistic semantic mapping based on the same performance report statistic identifier having next greatest semantic mapping priority should the extraction of the statistic value from the body of common format statistics fail for the currently selected statistic semantic mapping; and
d. generating the performance report statistic
whereby the use of semantic mapping priorities drives performance management reporting.

2. A method as claimed in claim 1, wherein extracting the statistic value from the body of common format statistics, the method further comprises a step of extracting a common format statistic identifier specified in the selected statistic semantic mapping.

3. A method as claimed in claim 2, wherein extracting the statistic value from the body of common format statistics, the method further comprises a step of querying the body of common format statistics based on the common format statistic identifier extracted.

4. A method as claimed in claim 1, wherein the statistic semantic mapping specifies a combination of a plurality of statistic values to generate the performance report statistic, the method further comprising a step of performing operations on the plurality of statistic values.

5. A method as claimed in claim 4, wherein subsequent to the step of selecting the statistic semantic mapping, the method further comprises a step of extracting from the selected statistic semantic mapping at least one operand and a plurality of common format statistic identifiers.

6. A method as claimed in claim 1, wherein subsequent to extracting the statistic value from the body of common format statistics, the method further comprises a step of performing a unit conversion on the extracted statistic value.

7. A method as claimed in claim 1, wherein subsequent to generating the performance report statistic, the method further comprises a step of performing a unit conversion on the generated performance report statistic.

8. A method as claimed in claim 1, wherein the method includes a prior step of selecting the performance report statistic to be generated, the selection of the performance report statistic is made from a body of performance reporting metadata.

9. A method as claimed in claim 8, wherein selecting the performance report statistic to be generated, the method further comprises a step of extracting the performance report statistic identifier used in the selection of statistic semantic mapping for the generation of the performance report statistic.

10. A method as claimed in claim 8, wherein prior to the selection of performance report statistics to be generated, the method further comprises a step of generating the body of common format statistics from raw statistic information received from at least one managed network element.

11. A method as claimed in claim 10, wherein generating the body of common format statistics, the method further comprises steps of:
a. extracting a vendor statistic identifier for each raw statistic provided;
b. selecting a specification for the generation of the corresponding common format statistic from a body of vendor statistics metadata based on the vendor statistic identifier; and
c. generating the corresponding common format statistic according to the specification
whereby the use of the body of vendor statistics metadata reduces the need for re-coding parsing software in processing raw statistic information.

12. A method as claimed in claim 11, wherein generating the common format statistic, the method further includes a step of normalizing the associated statistical value of the raw statistic with respect to units of measurement.

13. A method as claimed in claim 11, wherein generating the common format statistic, the method further includes a step of ascribing an associated common format identifier to the common format statistic.

14. A performance management reporting processor implementing the method claimed in claim 1.

15. A performance management reporting workstation implementing the method claimed in claim 1.

16. A software application implementing the method claimed in claim 1.

17. A firmware application implementing the method claimed in claim 1.
